(19) United States
(12) Patent Application Publication
(10) Pub. No.: US 2026/0026491 A1
(43) Pub. Date: Jan. 29, 2026

(54) SMART SPRAYER LOGGING

(71) Applicant: BASF AGRO TRADEMARKS GMBH, Ludwigshafen am Rhein (DE)

(72) Inventors: Daniel EBERSOLD, Limburgerhof (DE); Clemens Christian DELATREE, Münster (DE); Dominic STURM, Koeln (DE); Guilherme FAGANELLO DRESSANO, Sao Paulo (BR); Greg Robert KRUGER, Durham, NC (US); Holger HOFFMANN, Koeln (DE); Andrew David HUNT, Durham, NC (US); Steffen TELGMANN, Köin (DE); Marcel Enzo GAUER, Köin (DE); Peter HOEPER, Köin (DE); Erik HASS, Köin (DE); Carvin Guenther SCHEEL, Köin (DE); Bjoern KIEPE, Twistetal (DE)

(21) Appl. No.: 18/994,290

(22) PCT Filed: Jul. 13, 2023
(86) PCT No.: PCT/EP2023/069437

§ 371 Date: Jan. 14, 2025

(30) Foreign Application Priority Data
Jul. 14, 2022 (EP) 22184983.9

(51) Int. Cl. A01M 7/00

(52) U.S. Cl. CPC A01M 7/0089

(57) ABSTRACT

A computer-implemented method for operating an agricultural device, the method comprising the steps of:
providing agricultural operation data for an agricultural device, wherein the agricultural operation data comprise treatment operation data and/or monitoring operation data;
wherein if the agricultural operation data comprise treatment operation data and monitoring operation data, control data for controlling a treatment unit of the agricultural device are provided based on monitoring data provided by a monitoring unit of the agricultural device;
if the agricultural operation data comprise treatment operation data and no monitoring operation data, control data for controlling the treatment unit of the agricultural device are provided and monitoring data provided by the monitoring unit of the agricultural device are provided;
if the agricultural operation data comprise monitoring operation data and no treatment operation data, monitoring data provided by the monitoring unit of the agricultural device are provided.

### TECHNICAL FIELD

The present disclosure relates to a computer-implemented method for operating an agricultural device, an apparatus for operating an agricultural device, an use of control data for controlling a treatment unit of the agricultural device, an use of the agricultural operation data for an agricultural device, an agricultural device controlled by control data provided by the method, and a computer program element.

### TECHNICAL BACKGROUND

The general background of this disclosure is the operating of an agricultural device.

In conventional agricultural farming, agricultural devices are only instructed/capable to execute specific processes being necessary for a corresponding treatment of the agricultural field and/or plants. Specifically, when an application device is instructed to solely treat the agricultural field and/or plants on the basis of provided spatially resolved treatment data, only application units, e.g. sprayer, are controlled/activated. Simultaneously, other units, like monitoring units and/or cameras, being mounted on the agricultural device are deactivated and do not provide any data. Therefore, in current proceedings, the data collection depends on the to be executed specific processes being necessary for the corresponding treatment of the agricultural field and/or plants, wherein this dependency leads to an increased frequency of operation of the agricultural device, to an increased consumption of fuel, to an increase consumption of energy, to an increase consumption of man power, to an increase soil compaction and/or to increased environmental influences.

It has been found that a further need exists to make the operating of an agricultural device more sustainable by decreasing the frequency of operation of the agricultural device, decreasing the consumption of fuel, decreasing the consumption of energy, decreasing the consumption of man power, decreasing the soil compaction and/or decreasing the environmental influences.

### SUMMARY OF THE INVENTION

In one aspect of the present disclosure, a computer-implemented method for operating an agricultural device is provided, the method comprising the steps of:
providing agricultural operation data for an agricultural device, wherein the agricultural operation data comprise treatment operation data and/or monitoring operation data;
wherein if the agricultural operation data comprises treatment operation data and monitoring operating data, control data for controlling a treatment unit of the agricultural device are provided based on monitoring data provided by a monitoring unit of the agricultural device;
or if the agricultural operation data comprise treatment operation data and no monitoring operation data, control data for controlling the treatment unit of the agricultural device are provided and monitoring data provided by the monitoring unit of the agricultural device are provided;
or if the agricultural operation data comprise monitoring operation data and no treatment operation data, monitoring data provided by the monitoring unit of the agricultural device are provided.

In other words, one of the above three cases may be identified, one where the agricultural operation data comprises treatment operation data and monitoring operation data, one where the agricultural data comprises treatment operation data an does not comprise monitoring operation data, and one where the agricultural operation data comprises monitoring operation data and doe not comprise treatment operation data. Depending on which case is identified, the method may adopt different steps as outlined above. Thus, a flexibility in terms of operation modes is provided based on the above differentiation of the different cases.

In other words, in one aspect, a computer-implemented method for operating an agricultural device is provided, the method comprising the steps of:
providing agricultural operation data for an agricultural device, wherein the agricultural operation data comprise treatment operation data and/or monitoring operation data;
wherein, in case the agricultural operation data comprises treatment operation data and monitoring operation data, control data for controlling a treatment unit of the agricultural device are provided based on monitoring data provided by a monitoring unit of the agricultural device; and
wherein, in case the agricultural operation data comprise treatment operation data and no monitoring operation data, control data for controlling the treatment unit of the agricultural device are provided and monitoring data provided by the monitoring unit of the agricultural device are provided; and
wherein in case the agricultural operation data comprise monitoring operation data and no treatment operation data, monitoring data provided by the monitoring unit of the agricultural device are provided.

In yet other words, in one aspect, a computer-implemented method for operating an agricultural device is provided, the method comprising the steps of:
providing agricultural operation data for an agricultural device, wherein the agricultural operation data comprise treatment operation data and/or monitoring operation data;
wherein, in case it is determined that the agricultural operation data comprises treatment operation data and monitoring operation data, control data for controlling a treatment unit of the agricultural device are provided based on monitoring data provided by a monitoring unit of the agricultural device; and
wherein, in case it is determined that the agricultural operation data comprise treatment operation data and no monitoring operation data, control data for controlling the treatment unit of the agricultural device are provided and monitoring data provided by the monitoring unit of the agricultural device are provided; and
wherein, in case it is determined that the agricultural operation data comprise monitoring operation data and no treatment operation data, monitoring data provided by the monitoring unit of the agricultural device are provided.

In yet other words, in one aspect, a computer-implemented method for operating an agricultural device is provided, the method comprising the steps of:
providing agricultural operation data for an agricultural device, wherein the agricultural operation data comprise treatment operation data and/or monitoring operation data;
wherein, in response to determinig that the agricultural operation data comprises treatment operation data and monitoring operation data, control data for controlling a treatment unit of the agricultural device are provided based on monitoring data provided by a monitoring unit of the agricultural device; and
wherein, in response to determinig that the agricultural operation data comprise treatment operation data and no monitoring operation data, control data for controlling the treatment unit of the agricultural device are provided and monitoring data provided by the monitoring unit of the agricultural device are provided; and
wherein, in response to determinig that the agricultural operation data comprise monitoring operation data and no treatment operation data, monitoring data provided by the monitoring unit of the agricultural device are provided.

The method, particularly, may comprise determining whether the agricultural operation data comprise treatment operation data and determining whether the agriculatiral operation data comprise monitoring operation data. As specified above, depending on the outcome of the determining, it may be determined which of the above cases applies.

The terms “monitoring operation data” and “monitoring operating data” are used interchangeably herein. Moreover, the term “data” may be used interchangeably in singular or plural.

In a further aspect of the present disclosure, an apparatus for operating an agricultural device, the apparatus comprising:
one or more computing nodes and one or more computer-readable media having thereon computer-executable instructions that are structured such that, when executed by the one or more computing nodes, cause the apparatus to perform the following steps:
   providing agricultural operation data for an agricultural device, wherein the agricultural operation data comprise treatment operation data and/or monitoring operation data;
   wherein if the agricultural operation data comprises treatment operation data and monitoring operating data, control data for controlling a treatment unit of the agricultural device are provided based on monitoring data provided by a monitoring unit of the agricultural device;
   or if the agricultural operation data comprise treatment operation data and no monitoring operation data, control data for controlling the treatment unit of the agricultural device are provided and monitoring data provided by the monitoring unit of the agricultural device are provided;
   or if the agricultural operation data comprise monitoring operation data and no treatment operation data, monitoring data provided by the monitoring unit of the agricultural device are provided.

In other words, an apparatus for operating an agricultural device is provided, the apparatus comprising:
one or more computing nodes and one or more computer-readable media having thereon computer-executable instructions that are structured such that, when executed by the one or more computing nodes, cause the apparatus to perform the following steps:
   providing agricultural operation data for an agricultural device, wherein the agricultural operation data comprise treatment operation data and/or monitoring operation data;
   wherein, in case the agricultural operation data comprises treatment operation data and monitoring operation data, control data for controlling a treatment unit of the agricultural device are provided based on monitoring data provided by a monitoring unit of the agricultural device; and
   wherein, in case the agricultural operation data comprise treatment operation data and no monitoring operation data, control data for controlling the treatment unit of the agricultural device are provided and monitoring data provided by the monitoring unit of the agricultural device are provided; and
   wherein, in case the agricultural operation data comprise monitoring operation data and no treatment operation data, monitoring data provided by the monitoring unit of the agricultural device are provided.

In yet other words, an apparatus for operating an agricultural device is provided, the apparatus comprising:
one or more computing nodes and one or more computer-readable media having thereon computer-executable instructions that are structured such that, when executed by the one or more computing nodes, cause the apparatus to perform the following steps:
   providing agricultural operation data for an agricultural device, wherein the agricultural operation data comprise treatment operation data and/or monitoring operation data;
   wherein, in case it is determined that the agricultural operation data comprises treatment operation data and monitoring operation data, control data for controlling a treatment unit of the agricultural device are provided based on monitoring data provided by a monitoring unit of the agricultural device; and
   wherein, in case it is determined that the agricultural operation data comprise treatment operation data and no monitoring operation data, control data for controlling the treatment unit of the agricultural device are provided and monitoring data provided by the monitoring unit of the agricultural device are provided; and
   wherein, in case it is determined that the agricultural operation data comprise monitoring operation data and no treatment operation data, monitoring data provided by the monitoring unit of the agricultural device are provided.

In yet other words, an apparatus for operating an agricultural device is provided, the apparatus comprising:
one or more computing nodes and one or more computer-readable media having thereon computer-executable instructions that are structured such that, when executed by the one or more computing nodes, cause the apparatus to perform the following steps:
   providing agricultural operation data for an agricultural device, wherein the agricultural operation data comprise treatment operation data and/or monitoring operation data;
   wherein, in response to determinig that the agricultural operation data comprises treatment operation data and monitoring operation data, control data for controlling a treatment unit of the agricultural device are provided based on monitoring data provided by a monitoring unit of the agricultural device; and
   wherein, in response to determinig that the agricultural operation data comprise treatment operation data and no monitoring operation data, control data for controlling the treatment unit of the agricultural device are provided and monitoring data provided by the monitoring unit of the agricultural device are provided; and
   wherein, in response to determinig that the agricultural operation data comprise monitoring operation data and no treatment operation data, monitoring data provided by the monitoring unit of the agricultural device are provided.
The instructions may further be configured to cause the apparatus to determine whether the agricultural operation data comprise treatment operation data and to determine whether the agriculatiral operation data comprise monitoring operation data. Depending on the outcome of the determining, it may be determined which of the above cases applies.

In a further aspect, a computer element, in particular a computer program product or a computer readable medium, with instructions, which when executed on one or more computing node(s) is configured to carry out the steps of the method disclosed herein in any of the systems disclosed herein is presented.

In a further aspect, the use of control data for controlling a treatment unit of the agricultural device as disclosed herein is presented.

In a further aspect, the use of agricultural operation data for an agricultural device, comprising treatment operation data and/or monitoring operation data, in a method as disclosed herein is presented.

In a further aspect, an agricultural device controlled by control data provided by the method as disclosed herein is presented.

In a further aspect of the present disclosure, a system for operating an agricultural device is provided, the system comprises:
a providing unit for providing agricultural operation data for an agricultural device, wherein the agricultural operation data comprise treatment operation data and/or monitoring operation data;
wherein if the agricultural operation data comprises treatment operation data and monitoring operating data, control data for controlling a treatment unit of the agricultural device are provided based on monitoring data provided by a monitoring unit of the agricultural device;
or if the agricultural operation data comprise treatment operation data and no monitoring operation data, control data for controlling the treatment unit of the agricultural device are provided and monitoring data provided by the monitoring unit of the agricultural device are provided;
or if the agricultural operation data comprise monitoring operation data and no treatment operation data, monitoring data provided by the monitoring unit of the agricultural device are provided.
In other words, in case the agricultural operation data comprises treatment operation data and monitoring operating data, control data for controlling a treatment unit of the agricultural device are provided based on monitoring data provided by a monitoring unit of the agricultural device; and
in case the agricultural operation data comprise treatment operation data and no monitoring operation data, control data for controlling the treatment unit of the agricultural device are provided and monitoring data provided by the monitoring unit of the agricultural device are provided; and
in case the agricultural operation data comprise monitoring operation data and no treatment operation data, monitoring data provided by the monitoring unit of the agricultural device are provided.
In yet other words, in case it is determined that the agricultural operation data comprises treatment operation data and monitoring operating data, control data for controlling a treatment unit of the agricultural device are provided based on monitoring data provided by a monitoring unit of the agricultural device; and
in case it is determined that the agricultural operation data comprise treatment operation data and no monitoring operation data, control data for controlling the treatment unit of the agricultural device are provided and monitoring data provided by the monitoring unit of the agricultural device are provided; and
in case it is determined that the agricultural operation data comprise monitoring operation data and no treatment operation data, monitoring data provided by the monitoring unit of the agricultural device are provided.
In yet other words, in response to determining that the agricultural operation data comprises treatment operation data and monitoring operating data, control data for controlling a treatment unit of the agricultural device are provided based on monitoring data provided by a monitoring unit of the agricultural device; and
in response to determining that the agricultural operation data comprise treatment operation data and no monitoring operation data, control data for controlling the treatment unit of the agricultural device are provided and monitoring data provided by the monitoring unit of the agricultural device are provided; and
in response to determining that the agricultural operation data comprise monitoring operation data and no treatment operation data, monitoring data provided by the monitoring unit of the agricultural device are provided

Any disclosure and embodiments described herein relate to the methods, the apparatus, the system, the computer program element lined out above and vice versa.

Advantageously, the benefits provided by any of the embodiments and examples equally apply to all other embodiments and examples and vice versa.

As used herein “determining” also includes “initiating or causing to determine”, “generating” also includes “initiating or causing to generate” and “providing” also includes “initiating or causing to determine, generate, select, send or receive”. “Initiating or causing to perform an action” includes any processing signal that triggers a computing device to perform the respective action.

The methods, apparatus, systems, computer program elements/products and computer readable media disclosed herein provide an efficient, sustainable and robust way for improving the sustainability of the operating of an agricultural device. By overcoming/resolving the dependency between the data collection and the to be executed specific processes being necessary for the corresponding treatment of the agricultural field and/or plants, in other words always providing monitoring data even in a treatment only process, the frequency of operation of the agricultural device can be decreased and therefore the consumption of fuel, the consumption of energy, the consumption of man power, the soil compaction and/or the environmental influences can be significantly reduced.

It is an object of the present invention to provide an efficient, sustainable and robust way for improving the sustainability of the operating of an agricultural device. These and other objects, which become apparent upon reading the following description, are solved by the subject matter of the independent claims. The dependent claims refer to preferred embodiments of the invention.

The term operation as used herein is to be understood broadly in the present case and represents any processes for controlling of an agricultural device, for providing of data to or from the agricultural field, in particular the providing of monitoring data by a monitoring unit of the agricultural device, but is not limited thereto.

The term providing as used herein is to be understood broadly in the present case and represents any providing, receiving, querying, measuring, calculating, determining, transmitting of data, but is not limited thereto. Data may be provided by a user via a user interface, depicted/shown to a user by a display, and/or received from other devices, queried from other devices, measured other devices, calculated by other device, determined by other devices and/or transmitted by other devices.

The term data as used herein is to be understood broadly in the present case and represents any kind of data. Data may be single numbers/numerical values, a plurality of a numbers/numerical values, a plurality of a numbers/numerical values being arranged within a list, 2 dimensional maps or 3 dimensional maps, but are not limited thereto.

The term agricultural device as used herein is to be understood broadly in the present case and comprises any device configured to treat an agricultural field. The agricultural device may be configured to traverse the agricultural field. The agricultural device may be a ground or an air vehicle, e.g. a rail vehicle, a robot, an aircraft, an unmanned arial vehicle (UAV), a drone, or the like. The agricultural device may by equipped with one or more treatment unit(s) and/or one or more monitoring unit(s). The agricultural device may be configured to collect field data via the treatment and/or monitoring unit. The agricultural device may be configured to sense field data of the agricultural field via the monitoring unit. The agricultural device may be configured to treat the agricultural field via the treatment unit. The term treatment unit as used herein is to be understood broadly and represents any device being able to treat the agricultural field and/or plants on the agricultural field. The term treatment or treat as used herein may relate to any treatment for the cultivation of plants and/or the soil of the agricultural field. The term treating or treatment is to be understood broadly in the present case and relates to any treatments of the agricultural field such as seeding, applying products, harvesting etc. Treatment unit(s) may be operated based on monitoring data provided by the monitoring unit(s) of the agricultural device. Exemplary, treatment units may be a spot sprayer, but is not limited thereto. The term monitoring unit as used herein is to be understood broadly and relates to any device providing monitoring operation. Monitoring operation refers to an operation of the treatment device for monitoring the agricultural field, particularly collecting field data of the agricultural field. A monitoring operation identifier may indicate monitoring operation. Monitoring operation may be characterized by a monitoring type and/or a monitoring mode. Monitoring type refers to a monitoring indication, such as plant sensing for weed treatment, soil sensing for seeding, and the like. Monitoring mode refers to the mode or a class of modes for a single monitoring type. For plant sensing, modes may be weed image detection, crop image detection, fungi optical detection or the like. Monitoring operation may include any data for characterization, activation or operation of the treatment device for monitoring the agricultural field. The agricultural device may comprise a communication unit for connectivity. Via the communication unit the agricultural device may be configured to provide or send field data, to provide or receive operation data and/or to provide or receive operation data.

The term agricultural operation data as used herein is to be understood broadly in the present case and refers to any data comprising treatment operation data and/or monitoring operation data of an agricultural field. The agricultural operation data may be single numbers/numerical values, a plurality of a numbers/numerical values, a plurality of a numbers/numerical values being arranged within a list, 2 dimensional maps or 3 dimensional maps, but are not limited thereto.

The term treatment operation data as used herein is to be understood broadly in the present case and refers to any data comprising information about when, what, where and/or how and agricultural product is to be applied onto an agricultural field and/or on a plant on the agricultural field, but is not limited thereto. The “when” comprises information about an application time, i.e. data comprising at least one time window for applying an agricultural product, like soil herbicide product, on the agricultural field, but is not limited thereto. The “what” comprises information about the type, material and/or suitability of at least one agricultural product for an application on the agricultural field, wherein the suitability is e.g. at least based on soil property data and the soil moisture data of the agricultural field, but is not limited thereto. The “how” comprises information about the volume to be applied, e.g. 150 liter, and/or the type of application, e.g. application by a spot sprayer, but is not limited thereto. Further, the “how” may include dose rate data. The dose rate is the quantity of radiation absorbed or delivered per unit time. The dose rate for applying an agricultural product on the agricultural field may be provided for the surface or sub-areas of the agricultural field. The “where” comprises information about the location of the application of the agricultural product onto the agricultural field. The treatment operation data may be provided/presented as at least one agricultural product application map. The agricultural product application map may be a 2-dimensional or a 3-dimensional map. The treatment operation data may comprise instructions, tasks for application devices, and/or applicators to guide a soil property dependent variable rate application of the agricultural product.

The term monitoring operation data as used herein is to be understood broadly in the present case and refers to any data comprising information about if a monitoring operation should be/is/will be executed or if a monitoring operation shouldn't be/is not/will not be executed, but is not limited thereto. The monitoring data may comprise the values “0” for no monitoring operation is executed and “1” for a monitoring operation is executed, but is not limited thereto.

The term monitoring data as used herein is to be understood broadly in the present case and refers to any data being provided, in particular measured, by a monitoring unit, e.g. a camera. Monitoring data may be provided as single numbers/numerical values, a plurality of a numbers/numerical values, a plurality of a numbers/numerical values being arranged within a list, 2 dimensional maps or 3 dimensional maps, but are not limited thereto.

The term control data as used herein is to be understood broadly in the present case and relates to any data configured to operate and control an application device and/or a treatment unit. The control data are provided by a control unit and may be configured to control one or more technical means of the device and/or the means, e.g. the drive control but is not limited thereto.

The term collection unit as used herein is to be understood broadly in the present case and refers to any unit being capable to collect monitoring data and/or to be provided with monitoring data. Exemplary, the collection unit may be a central computing device being wireless or by wire connected to the application device, but is not limited thereto. The collection unit may comprise a storage mean for storing the received monitoring data. Additionally or alternatively, the collection unit may be a cloud application, wherein the monitoring data may also be processed in whole or in part in the cloud application and/or in the collection unit (e.g., by cloud computing).

The term mode selection as used herein is to be understood broadly in the present case and refers to any selection and/or classification of a mode of an agricultural device, in particular the operation to be executed by the agricultural device. The mode may be a single mode or a plurality of modes. The modes may be monitoring, treating, monitoring and treating, but are not limited thereto.

The term prediction data as used herein is to be understood broadly in the present case and represents any data being provided by a computer-operable model, method, mathematical algorithm, which can be used to calculate/estimate/predict agricultural operation data, i.e. treatment operation data and/or monitoring operation data. Such a prediction model may be at least based on the monitoring data.

In an embodiment, if the agricultural operation data comprises treatment operation data and monitoring operating data, monitoring data provided by the monitoring unit of the agricultural device are provided. By providing the monitoring data of the case that the agricultural operation data comprises treatment operation data and monitoring operating data an efficient, sustainable and robust way for improving the sustainability of the operating of an agricultural device can be provided.

In an embodiment, the method further comprises mode selection based on the agricultural operation data. By providing the selection of the modes an efficient, calculating time saving, computing capacity saving, sustainable and robust way for improving the sustainability of the operating of an agricultural device can be provided.

In an embodiment, the method further comprises providing monitoring data to at least one further agricultural device. By providing the monitoring data to at least one further agricultural device a decentral, efficient, sustainable and robust way for improving the sustainability of the operating of an agricultural device can be provided.

In an embodiment, the method further comprises providing monitoring data to a collection unit. By providing the monitoring data to at least one further agricultural device a central, efficient, sustainable and robust way for improving the sustainability of the operating of an agricultural device can be provided.

In an embodiment, the method further comprises providing further agricultural operation data based on the provided monitoring data. By providing the further agricultural operation data an efficient, sustainable and robust way for improving the sustainability of the operating of an agricultural device can be provided.

In an embodiment, the method further comprises providing prediction data based on the monitoring data and providing further agricultural operation data based on the prediction data. By providing the further agricultural operation data based on prediction data an efficient, sustainable and robust way for improving the sustainability of the operating of an agricultural device can be provided.

In an embodiment, the method further comprises transmitting the further agricultural operation data to the further agricultural device. By transmitting the further agricultural operation data to the further agricultural device an efficient, decentral, sustainable and robust way for improving the sustainability of the operating of an agricultural device can be provided.

In an embodiment, the method further comprises providing control data based on the to further agricultural device or based on the collection unit. By providing the control data an efficient, sustainable and robust way for improving the sustainability of the operating of an agricultural device can be provided.

### BRIEF DESCRIPTION OF THE DRAWINGS

In the following, the present disclosure is further described with reference to the enclosed figures:

FIG. 1 illustrate example embodiments of a centralized and a decentralized computing environment with computing nodes;

FIG. 2 illustrate example embodiments of a centralized and a decentralized computing environment with computing nodes;

FIG. 3 illustrate an example embodiment of a distributed computing environment;

FIG. 4 illustrates a flow diagram of an example method for operating an agricultural device;

FIG. 5 illustrates an example embodiment for providing monitoring data;

FIG. 6 illustrates another example embodiment for providing monitoring data.

### DETAILED DESCRIPTION OF EMBODIMENT

The following embodiments are mere examples for implementing the methods, the systems, the apparatus or the computer elements disclosed herein and shall not be considered limiting.

The following embodiments are mere examples for implementing the method, the system, the apparatus, or application device disclosed herein and shall not be considered limiting.

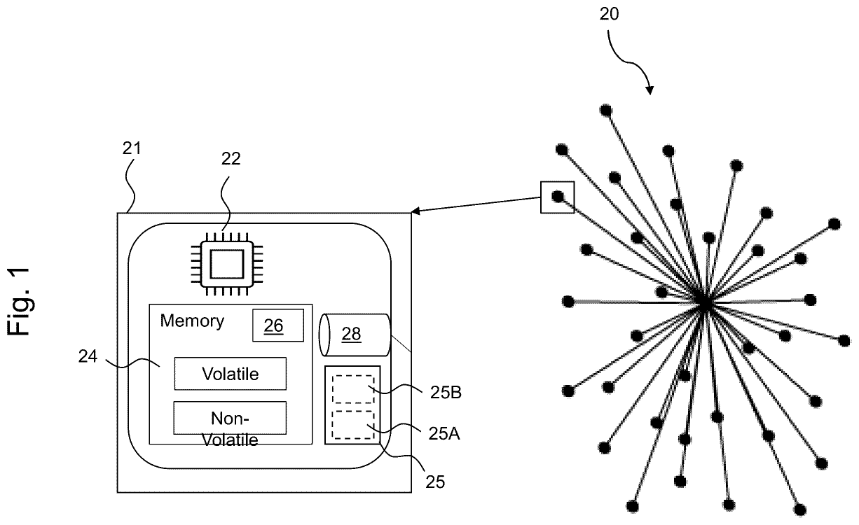

FIGS. 1 to 3 illustrate different computing environments, central, decentral and distributed. The methods, apparatuses, systems, computer elements of this disclosure may be implemented in decentral or at least partially decentral computing environments. In particular, providing of data may be realized by different computing nodes, which may be implemented in a centralized, a decentralized or a distributed computing environment. Furthermore, determination of data may be realized by different computing nodes, which may be implemented in a centralized, a decentralized, or a distributed computing environment.

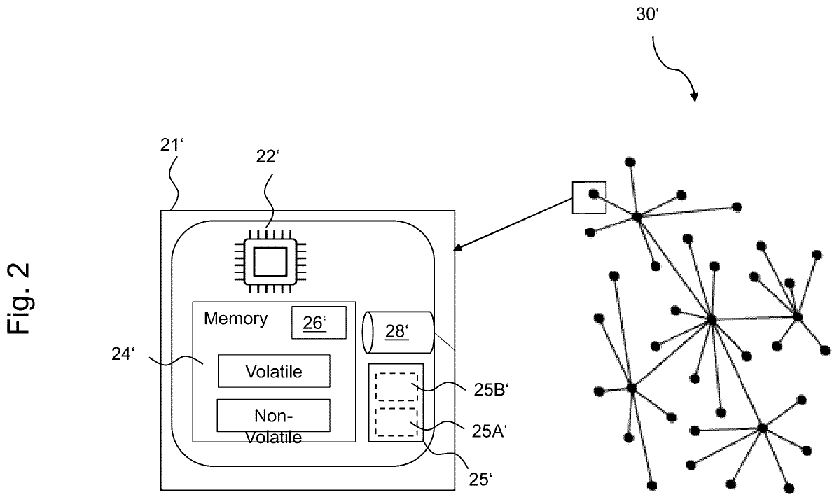

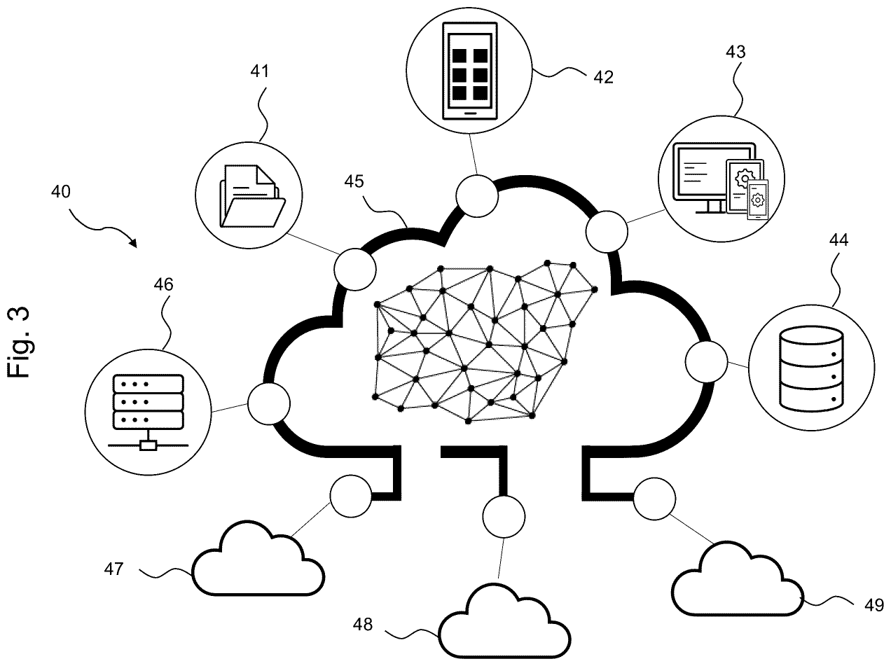

FIGS. 1 and 2 illustrate example embodiments of a centralized and a decentralized computing environment with computing nodes. FIG. 3 illustrates an example embodiment of a distributed computing environment.

FIG. 1 illustrates an example embodiment of a centralized computing system 20 comprising a central computing node 21 (filled circle in the middle) and several peripheral computing nodes 21.1 to 21.n (denoted as filled circles in the periphery). The term “computing system” is defined herein broadly as including one or more computing nodes, a system of nodes or combinations thereof. The term “computing node” is defined herein broadly and may refer to any device or system that includes at least one physical and tangible processor, and/or a physical and tangible memory capable of having thereon computer-executable instructions that are executed by a processor. Computing nodes are now increasingly taking a wide variety of forms. Computing nodes may, for example, be handheld devices, production facilities, sensors, monitoring systems, control systems, appliances, laptop computers, desktop computers, mainframes, data centers, or even devices that have not conventionally been considered a computing node, such as wearables (e.g., glasses, watches or the like). The memory may take any form and depends on the nature and form of the computing node.

In this example, the peripheral computing nodes 21.1 to 21.n may be connected to one central computing system (or server). In another example, the peripheral computing nodes 21.1 to 21.n may be attached to the central computing node via e.g. a terminal server (not shown). The majority of functions may be carried out by, or obtained from the central computing node (also called remote centralized location). One peripheral computing node 21.n has been expanded to provide an overview of the components present in the peripheral computing node. The central computing node 21 may comprise the same components as described in relation to the peripheral computing node 21.n.

Each computing node 21, 21.1 to 21.n may include at least one hardware processor 22 and memory 24. The term “processor” may refer to an arbitrary logic circuitry configured to perform basic operations of a computer or system, and/or, generally, to a device which is configured for performing calculations or logic operations. In particular, the processor, or computer processor may be configured for processing basic instructions that drive the computer or system. It may be a semi-conductor based processor, a quantum processor, or any other type of processor configures for processing instructions. As an example, the processor may comprise at least one arithmetic logic unit (“ALU”), at least one floating-point unit (“FPU)”, such as a math coprocessor or a numeric coprocessor, a plurality of registers, specifically registers configured for supplying operands to the ALU and storing results of operations, and a memory, such as an L1 and L2 cache memory. In particular, the processor may be a multicore processor. Specifically, the processor may be or may comprise a Central Processing Unit (“CPU”). The processor may be a (“GPU”) graphics processing unit, (“TPU”) tensor processing unit, (“CISC”) Complex Instruction Set Computing microprocessor, Reduced Instruction Set Computing (“RISC”) microprocessor, Very Long Instruction Word (“VLIW”) microprocessor, or a processor implementing other instruction sets or processors implementing a combination of instruction sets. The processing means may also be one or more special-purpose processing devices such as an Application-Specific Integrated Circuit (“ASIC”), a Field Programmable Gate Array (“FPGA”), a Complex Programmable Logic Device (“CPLD”), a Digital Signal Processor (“DSP”), a network processor, or the like. The methods, systems and devices described herein may be implemented as software in a DSP, in a micro-controller, or in any other side-processor or as hardware circuit within an ASIC, CPLD, or FPGA. It is to be understood that the term processor may also refer to one or more processing devices, such as a distributed system of processing devices located across multiple computer systems (e.g., cloud computing), and is not limited to a single device unless otherwise specified.

The memory 24 may refer to a physical system memory, which may be volatile, non-volatile, or a combination thereof. The memory may include non-volatile mass storage such as physical storage media. The memory may be a computer-readable storage media such as RAM, ROM, EEPROM, CD-ROM, or other optical disk storage, magnetic disk storage, or other magnetic storage devices, non-magnetic disk storage such as solid-state disk or any other physical and tangible storage medium which can be used to store desired program code means in the form of computer-executable instructions or data structures and which can be accessed by the computing system. Moreover, the memory may be a computer-readable media that carries computer-executable instructions (also called transmission media). Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing components that also (or even primarily) utilize transmission media.

The computing nodes 21, 21.1 to 21.n may include multiple structures 26 often referred to as an “executable component, executable instructions, computer-executable instructions or instructions”. For instance, memory 24 of the computing nodes 21, 21.1 to 21.n may be illustrated as including executable component 26. The term “executable component” or any equivalent thereof may be the name for a structure that is well understood to one of ordinary skill in the art in the field of computing as being a structure that can be software, hardware, or a combination thereof or which can be implemented in software, hardware, or a combination. For instance, when implemented in software, one of ordinary skill in the art would understand that the structure of an executable component includes software objects, routines, methods, and so forth, that is executed on the computing nodes 21, 21.1 to 21.n, whether such an executable component exists in the heap of a computing node 21, 21.1 to 21.n, or whether the executable component exists on computer-readable storage media. In such a case, one of ordinary skill in the art will recognize that the structure of the executable component exists on a computer-readable medium such that, when interpreted by one or more processors of a computing node 21, 21.1 to 21.n (e.g., by a processor thread), the computing node 21, 21.1 to 21n is caused to perform a function. Such a structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”. Examples of executable components implemented in hardware include hardcoded or hard-wired logic gates, that are implemented exclusively or near-exclusively in hardware, such as within a field-programmable gate array (FPGA), an application-specific integrated circuit (ASIC), or any other specialized circuit. In this description, the terms “component”, “agent”, “manager”, “service”, “engine”, “module”, “virtual machine” or the like are used synonymous with the term “executable component.

The processor 22 of each computing node 21, 21.1 to 21.n may direct the operation of each computing node 21, 21.1 to 21.n in response to having executed computer-executable instructions that constitute an executable component. For example, such computer-executable instructions may be embodied on one or more computer-readable media that form a computer program product. The computer-executable instructions may be stored in the memory 24 of each computing node 21, 21.1 to 21.n. Computer-executable instructions comprise, for example, instructions and data which, when executed at a processor 21, cause a general purpose computing node 21, 21.1 to 21.n, special purpose computing node 21, 21.1 to 21.n, or special purpose processing device to perform a certain function or group of functions. Alternatively or in addition, the computer-executable instructions may configure the computing node 21, 21.1 to 21.n to perform a certain function or group of functions. The computer executable instructions may be, for example, binaries or even instructions that undergo some translation (such as compilation) before direct execution by the processors, such as intermediate format instructions such as assembly language, or even source code.

Each computing node 21, 21.1 to 21.n may contain communication channels 28 that allow each computing node 21.1 to 21.n to communicate with the central computing node 21, for example, a network (depicted as solid line between peripheral computing nodes and the central computing node in FIG. 1). A “network” may be defined as one or more data links that enable the transport of electronic data between computing nodes 21, 21.1 to 21.n and/or modules and/or other electronic devices. When information is transferred or provided over a network or another communications connection (either hardwired, wireless, or a combination of hardwired or wireless) to a computing node 21, 21.1 to 21.n, the computing node 21, 21.1 to 21.n properly views the connection as a transmission medium. Transmission media can include a network and/or data links which can be used to carry desired program code means in the form of computer-executable instructions or data structures and which can be accessed by a general-purpose or special-purpose computing nodes 21, 21.1 to 21.n. Combinations of the above may also be included within the scope of computer-readable media.

The computing node(s) 21, 21.1 to 21.n may further comprise a user interface system 25 for use in interfacing with a user. The user interface system 25 may include output mechanisms 25A as well as input mechanisms 25B. The principles described herein are not limited to the precise output mechanisms 25A or input mechanisms 25B as such will depend on the nature of the device. However, output mechanisms 25A might include, for instance, displays, speakers, displays, tactile output, holograms and so forth. Examples of input mechanisms 25B might include, for instance, microphones, touchscreens, holograms, cameras, keyboards, mouse or other pointer input, sensors of any type, and so forth.

FIG. 2 illustrates an example embodiment of a decentralized computing environment 30 with several computing nodes 21.1 to 21.n denoted as filled circles. In contrast to the centralized computing environment 20 illustrated in FIG. 1, the computing nodes 21.1 to 21.n of the decentralized computing environment are not connected to a central computing node 21 and are thus not under control of a central computing node. Instead, resources, both hardware and software, may be allocated to each individual computing node 21.1 to 21.n (local or remote computing system) and data may be distributed among various computing nodes 21.1 to 21.n to perform the tasks. Thus, in a decentral system environment, program modules may be located in both local and remote memory storage devices. One computing node 21 has been expanded to provide an overview of the components present in the computing node 21. In this example, the computing node 21 comprises the same components as described in relation to FIG. 1.

FIG. 3 illustrates an example embodiment of a distributed computing environment 40. In this description, “distributed computing” may refer to any computing that utilizes multiple computing resources. Such use may be realized through virtualization of physical computing resources. One example of distributed computing is cloud computing. “Cloud computing” may refer a model for enabling on-demand network access to a shared pool of configurable computing resources (e.g., networks, servers, storage, applications, and services). When distributed, cloud computing environments may be distributed internationally within an organization and/or across multiple organizations. In this example, the distributed cloud computing environment 40 may contain the following computing resources: mobile device(s) 42, applications 43, databases 44, data storage and server(s) 46. The cloud computing environment 40 may be deployed as public cloud 47, private cloud 48 or hybrid cloud 49. A private cloud 47 may be owned by an organization and only the members of the organization with proper access can use the private cloud 48, rendering the data in the private cloud at least confidential. In contrast, data stored in a public cloud 48 may be open to anyone over the internet. The hybrid cloud 49 may be a combination of both private and public clouds 47, 48 and may allow to keep some of the data confidential while other data may be publicly available.

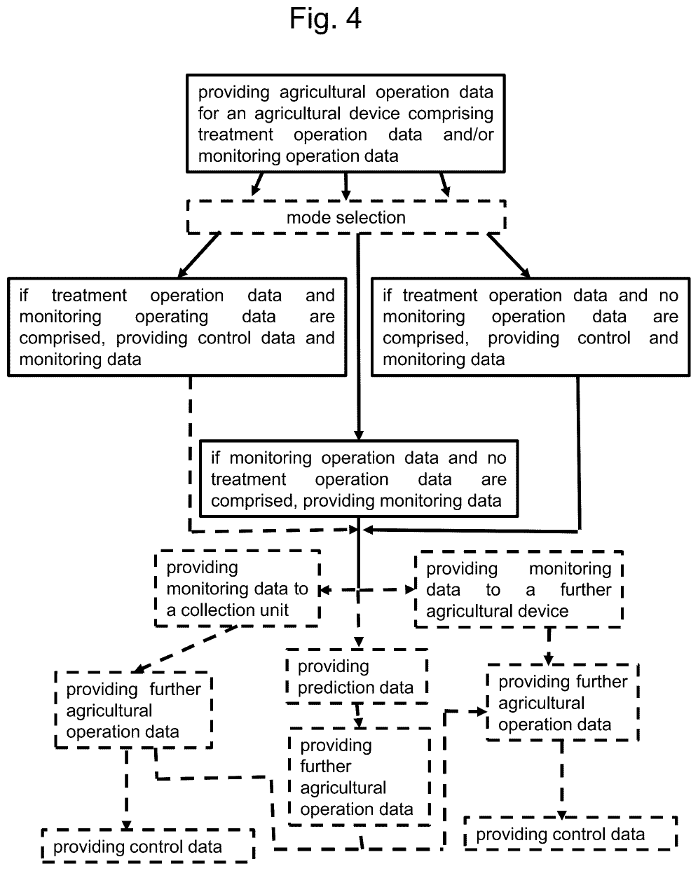

FIG. 4 illustrates a flow diagram of an example method for operating an agricultural device. The computer-implemented method for operating an agricultural device, comprises the following steps. In a first step agricultural operation data for an agricultural device are provided, wherein the agricultural operation data comprise treatment operation data and/or monitoring operation data. In case, the agricultural operation data comprises treatment operation data and monitoring operating data, control data for controlling a treatment unit of the agricultural device are provided based on monitoring data provided by a monitoring unit of the agricultural device. In case, the agricultural operation data comprise treatment operation data and no monitoring operation data, control data for controlling the treatment unit of the agricultural device are provided and monitoring data provided by the monitoring unit of the agricultural device are provided. In case, the agricultural operation data comprise monitoring operation data and no treatment operation data, monitoring data provided by the monitoring unit of the agricultural device are provided.

Optionally, if the agricultural operation data comprises treatment operation data and monitoring operating data, monitoring data provided by the monitoring unit of the agricultural device are provided.

Optionally, the method further comprises a mode selection based on the agricultural operation data.

Optionally, the method further comprises a providing of monitoring data to at least one further agricultural device.

Optionally, the method further comprises a providing of monitoring data to a collection unit.

Optionally, the method further comprises a providing of further agricultural operation data based on the provided monitoring data.

Optionally, the method further comprises a providing of prediction data based on the monitoring data and providing further agricultural operation data based on the prediction data.

Optionally, the method further comprises a transmitting the further agricultural operation data to the further agricultural device.

Optionally, the method further comprises a providing of control data based on the to further agricultural device or based on the collection unit.

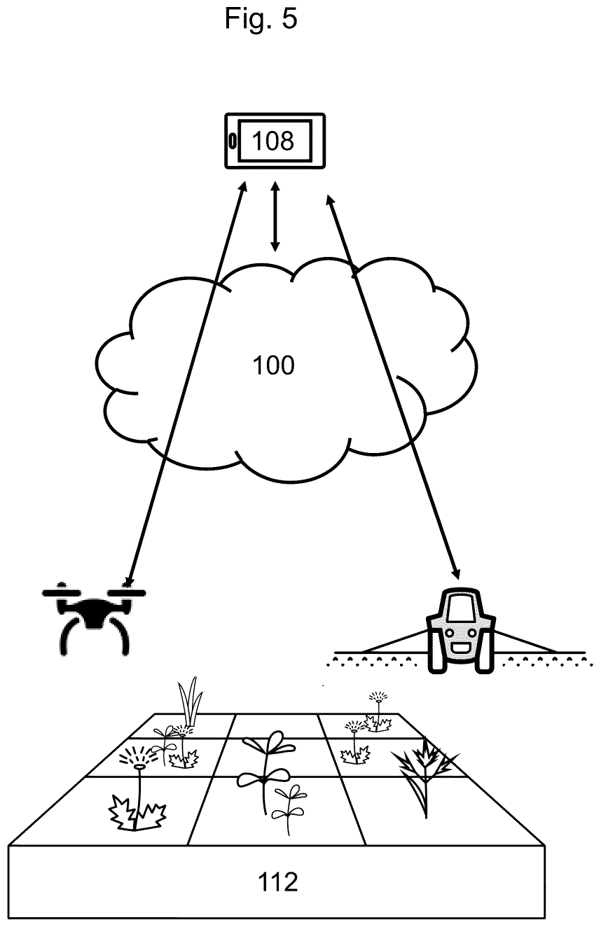

FIG. 5 illustrates an example embodiment for providing monitoring data.

The monitoring data are provided by a plurality of drones 102, 104, 106 each comprising a camera for providing monitoring data of plants 113 onto an agricultural field 112. The drones 102, 104, 106 are configure to transmit the provided monitoring data to a computer system 110, to the cloud 100 and/or to a communication device 108. The drones 102, 104, 106 are able to transmit provided monitoring data to each other. The transmission is a wireless data transmission.

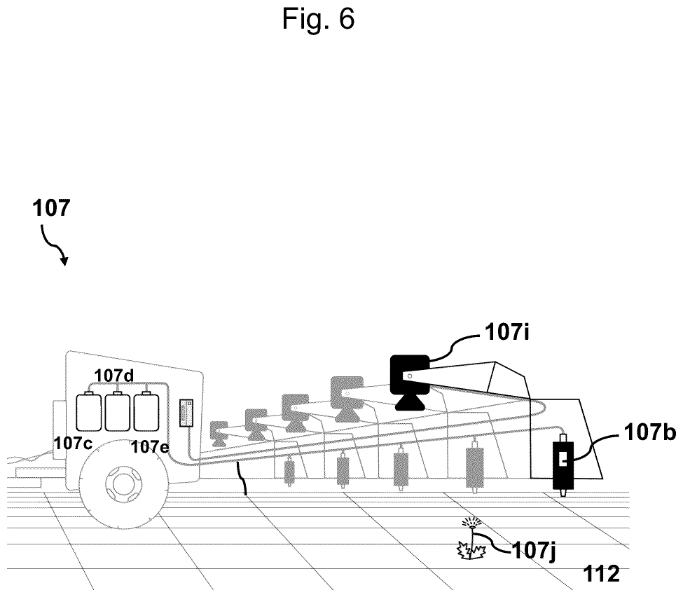

FIG. 6 illustrates another example embodiment for providing monitoring data.

The providing of monitoring data is provided by a plurality of cameras 107i being arranged at a boom of an agricultural device 107. The agricultural device 107 additionally comprises a plurality of tanks 107c, 107d, 107e each comprising a different crop protection product. The crop protection products are provided via nozzles 107b onto the plants, i.e. weed or crop plants, 107j onto an agricultural field 112.

The present disclosure has been described in conjunction with a preferred embodiment as examples as well. However, other variations can be understood and effected by those persons skilled in the art and practicing the claimed invention, from the studies of the drawings, this disclosure and the claims. Notably, in particular, the any steps presented can be performed in any order, i.e. the present invention is not limited to a specific order of these steps. Moreover, it is also not required that the different steps are performed at a certain place or at one node of a distributed system, i.e. each of the steps may be performed at a different nodes using different equipment/data processing units.

In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

### FURTHER EXAMPLES

1. A computer-implemented method for operating an agricultural device, the method comprising the steps of:
   providing agricultural operation data for an agricultural device, wherein the agricultural operation data comprise treatment operation data and/or monitoring operation data;
   wherein if the agricultural operation data comprises treatment operation data and monitoring operating data, control data for controlling a treatment unit of the agricultural device are provided based on monitoring data provided by a monitoring unit of the agricultural device;
   or if the agricultural operation data comprise treatment operation data and no monitoring operation data, control data for controlling the treatment unit of the agricultural device are provided and monitoring data provided by the monitoring unit of the agricultural device are provided;
   or if the agricultural operation data comprise monitoring operation data and no treatment operation data, monitoring data provided by the monitoring unit of the agricultural device are provided.
2. The method according to example 1,
   wherein if the agricultural operation data comprises treatment operation data and monitoring operating data, monitoring data provided by the monitoring unit of the agricultural device are provided.
3. The method according to any preceding example, further comprising mode selection based on the agricultural operation data.
4. The method according to any preceding example, further comprising the step of: providing monitoring data to at least one further agricultural device.
5. The method according to any preceding example, further comprising the step of: providing monitoring data to a collection unit.
6. The method according to one of examples 4 or 5, further comprising the step of: providing further agricultural operation data based on the provided monitoring data.
7. The method according to any preceding example, further comprising the step of: providing prediction data based on the monitoring data and providing further agricultural operation data based on the prediction data.
8. The method according to example 6 and 7, further comprising the step of: transmitting the further agricultural operation data to the further agricultural device.
9. The method according to any preceding example, further comprises the step of: providing control data based on the to further agricultural device or based on the collection unit.
10. An apparatus for operating an agricultural device, the apparatus comprising:
   one or more computing nodes and one or more computer-readable media having thereon computer-executable instructions that are structured such that, when executed by the one or more computing nodes, cause the apparatus to perform the following steps:
      providing agricultural operation data for an agricultural device, wherein the agricultural operation data comprise treatment operation data and/or monitoring operation data;
      wherein if the agricultural operation data comprises treatment operation data and monitoring operating data, control data for controlling a treatment unit of the agricultural device are provided based on monitoring data provided by a monitoring unit of the agricultural device;
      or if the agricultural operation data comprise treatment operation data and no monitoring operation data, control data for controlling the treatment unit of the agricultural device are provided and monitoring data provided by the monitoring unit of the agricultural device are provided;
      or if the agricultural operation data comprise monitoring operation data and no treatment operation data, monitoring data provided by the monitoring unit of the agricultural device are provided.
11. A computer program element with instructions, which when executed on one or more computing node(s) is configured to carry out the steps of the method of any one of the examples 1 to 7 or by the apparatus of example 8.
12. Use of control data according to examples 1 and/or 7 for controlling a treatment unit of the agricultural device.
13. Use of the agricultural operation data for an agricultural device, comprise treatment operation data and/or monitoring operation data, in an method according to example 1.
14. An agricultural device controlled by control data provided by the method according to example 1.

1. A computer-implemented method for operating an agricultural device, the method comprising the steps of:
providing agricultural operation data for an agricultural device, wherein the agricultural operation data comprise treatment operation data and/or monitoring operation data;
wherein, in case the agricultural operation data comprise treatment operation data and monitoring operation data, control data for controlling a treatment unit of the agricultural device are provided based on monitoring data provided by a monitoring unit of the agricultural device; and
wherein, in case the agricultural operation data comprise treatment operation data and no monitoring operation data, control data for controlling the treatment unit of the agricultural device are provided and monitoring data provided by the monitoring unit of the agricultural device are provided; and
wherein in case the agricultural operation data comprise monitoring operation data and no treatment operation data, monitoring data provided by the monitoring unit of the agricultural device are provided.

2. The method according to claim 1, wherein if the agricultural operation data comprise treatment operation data and monitoring operation data, monitoring data provided by the monitoring unit of the agricultural device are provided.

3. The method according to claim 1, further comprising mode selection based on the agricultural operation data.

4. The method according to claim 1, further comprising the step of: providing monitoring data to at least one further agricultural device.

5. The method according to claim 1, further comprising the step of: providing monitoring data to a collection unit.

6. The method according to claim 4, further comprising the step of: providing further agricultural operation data based on the provided monitoring data.

7. The method according to claim 1, further comprising the step of: providing prediction data based on the monitoring data and providing further agricultural operation data based on the prediction data.

8. The method according to claim 6, further comprising the step of:
transmitting the further agricultural operation data to the further agricultural device.

9. The method according to claim 1, further comprising the step of: providing control data based on the to further agricultural device or based on the collection unit.

10. The method according to claim 1, further comprising determining whether the agricultural operation data comprise treatment operation data and determining whether the agricultural operation data comprise monitoring operation data.

11. An apparatus for operating an agricultural device, the apparatus comprising:
one or more computing nodes and one or more computer-readable media having thereon computer-executable instructions that are structured such that, when executed by the one or more computing nodes, cause the apparatus to perform the following steps:
providing agricultural operation data for an agricultural device, wherein the agricultural operation data comprise treatment operation data and/or monitoring operation data;
wherein, in case the agricultural operation data comprise treatment operation data and monitoring operation data, control data for controlling a treatment unit of the agricultural device are provided based on monitoring data provided by a monitoring unit of the agricultural device; and
wherein, in case the agricultural operation data comprise treatment operation data and no monitoring operation data, control data for controlling the treatment unit of the agricultural device are provided and monitoring data provided by the monitoring unit of the agricultural device are provided; and
wherein, in case the agricultural operation data comprise monitoring operation data and no treatment operation data, monitoring data provided by the monitoring unit of the agricultural device are provided.

12. A computer program element with instructions, which when executed on one or more computing node(s) is configured to carry out the steps of the method of claim 1.

13. A method for controlling a treatment unit of an agricultural device comprising using control data according to claim 1.

14. (canceled)

15. An agricultural device controlled by control data provided by the method according to claim 1.
